(19) United States
(12) Patent Application Publication
(10) Pub. No.: US 2010/0193039 A1
(43) Pub. Date: Aug. 5, 2010

(54) Fluid Flow Control Systems

(76) Inventor: Paul Illingworth, West Yorkshire (GB)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(21) Appl. No.: 12/667,435

(22) PCT Filed: Jul. 7, 2008
(86) PCT No.: PCT/EP2008/058778

§ 371 Date: Feb. 12, 2010

(30) Foreign Application Priority Data
Jul. 6, 2007 (GB) 0713140.2

(51) Int. Cl. G05D 11/00; F16K 11/22

(52) U.S. Cl. 137/112; 137/606

(57) ABSTRACT

A fluid supply system or plumbing assembly includes a tap with at least one fluid inlet and a fluid outlet, and a diverter valve unit. The diverter valve unit is spatially separated from the tap and is connected to at least two different fluid sources, such as mains water and treated water. The diverter valve unit has at least two user selectable flow paths by means of which a selected fluid source can be supplied to the tap inlet.

The present disclosure relates to systems for controlling fluid flow, in particular in relation to the flow of water and water-based fluids, more especially in a domestic environment. In particular applications the disclosure relates to systems for modifying pre-existing fluid flow control means to provide for the flow of additional fluids and/or for flow through alternate or additional fluid dispensing means, in particular, through taps.

In a domestic environment, there are a number of situations in which flow control, and more especially flow selection, is required. For example, it may be desirable to provide a flow of non-potable water for general purposes such as dish washing and a separate flow of drinking water.

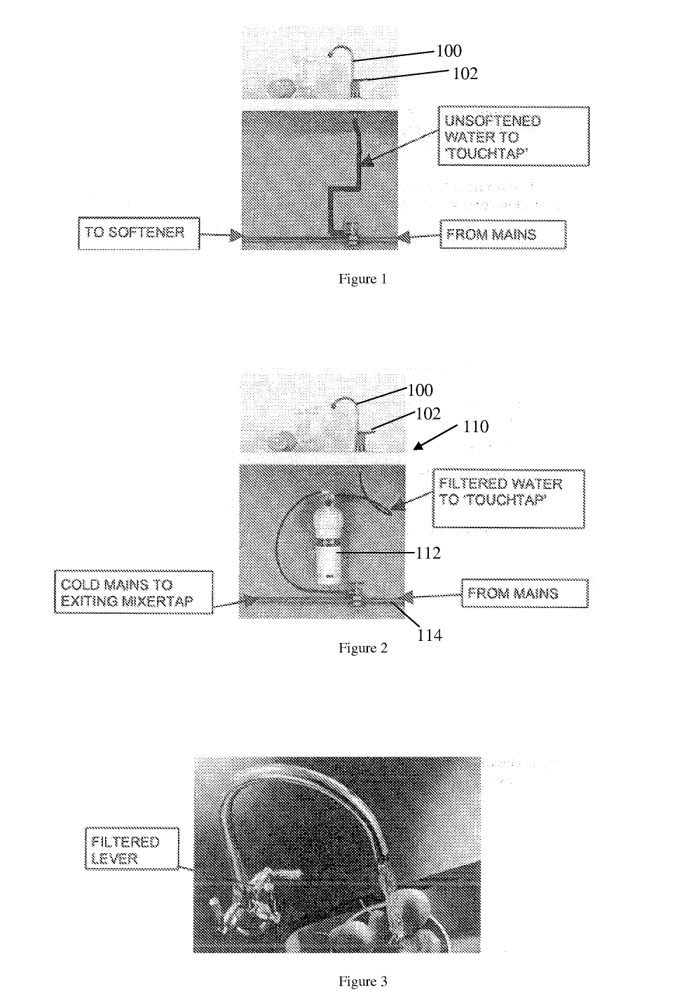

An example of a situation in which both potable water and non-potable water need to be separately provided is in the use of water softeners. In “hard water” areas, water softening devices are often used to improve the quality of water, for example for washing purposes and to prevent the accumulation of lime scale. However, softened water may not be suitable for drinking because the process of softening can introduce an unacceptably high level of sodium into the water. It is therefore necessary to provide a separate flow of water which has not passed through the water softener, specifically for drinking. This is often done by providing a specific drinking water tap. This is often a so-called “touch tap” 100, as illustrated in FIG. 1 of the accompanying drawings, which has an operating lever 102 biased towards the off “no flow” position. Depression of the lever by a user's finger allows potable water to flow from the tap 100. Alternatively, a three-way tap may be used, as illustrated in FIG. 3.

Another such situation is where a water filter is used. In this case, water from a water filter is directed to a specific drinking water tap whereas unfiltered water is directed through a conventional tap. A touch tap arrangement 110 for filtered water is illustrated in FIG. 2 of the accompanying drawings in which a water filter apparatus 112 is disposed between a mains supply 114 and a touch tap 100.

In a further example, in order to reduce water consumption, rainwater collection systems may be used. Rainwater is then used for general purposes such as washing and a separate flow of potable water is required, conventionally through a separate tap.

In all of these conventional arrangements, to provide the required added functionality it is necessary to modify an existing installation, for example by replacing a whole tap assembly with a new one and/or to provide an additional tap such as a touch tap. This is inconvenient and may be somewhat unsightly. The present disclosure seeks to overcome this and other disadvantages by providing means of selectably causing one of a plurality of available fluid flows to flow through a chosen fluid dispensing means (such as a pre-existing fluid dispensing means) and/or to selectably cause a given fluid to flow through a chosen one of a plurality of available fluid dispensing means.

WO 2004/104306 describes a tap having a tap body and a discharge spout. Three inlet feeds are connected to the tap body. A diverter valve is provided within or on the tap body which allows user selection between two of the inlet feeds.

EP 0 872 601 describes a tap having a tap body on which is mounted a cartridge of treatment material, typically for filtration or softening of water. The tap body is provided with two incoming feeds, typically hot water and cold water. A diverter within the tap body is used to direct water from the cold water supply through the cartridge of treatment material when required.

GB 2 314 115 describes a diverter valve for a waste water flow by means of which waste water can be selectively directed to a drain or to an alternative route such as to a hosepipe or to a storage vessel.

GB 2 394 525 describes a pillar-type tap having a tap body, respective hot and cold water tap valves communicating with a conventional outlet spout and a separate hand spray apparatus. A diverter arrangement is provided within the tap body and operates such that when one or both of the tap valves are open and the hand spray is actuated, water flow is diverted through the hand spray in preference to through the outlet spout.

WO 2005/003877 describes a mixer tap for a bath and shower arrangement. The tap includes a tap body and hot and cold water inlets. A first outlet is provided for bath filling and a second outlet is provided for operating a shower. A first control in the form of a knob is used to select the water output temperature. A second control in the form of a lever operates a diverter valve to direct the water flow selectively between the bath filling outlet and the shower outlet. The second control also determines a lower maximum temperature for operation of the shower than for bath filling.

The system of the present disclosure, although intended primarily for domestic use may also be suitable for use in other applications, such as offices, hotels and restaurants.

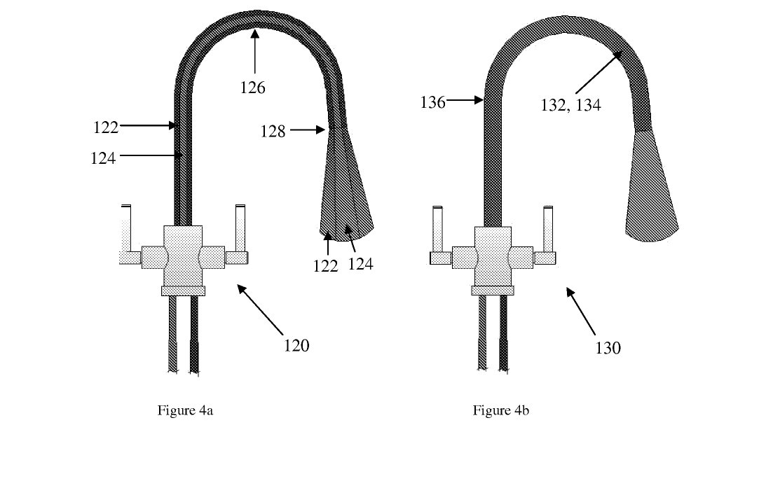

Some conventional fluid dispensing means are illustrated for reference in FIGS. 4a and 4b. FIG. 4a shows a twin supply dual flow arrangement 120 in which discrete flow paths 122,124 are provided within the dispenser 126 so that flows of, for example, hot and cold water are kept separate until the point of release 128 from the dispenser (tap). FIG. 4b shows a twin-supply single flow tap arrangement 130 in which, for example, hot and cold flows 132, 134 are mixed in the tap body 136 and as they emerge from the tap. In further alternatives (not illustrated) the fluid dispenser can be of a single supply design, suitable for providing a flow of either hot or cold water, depending on the particular installation. The flow control arrangement as described herein is suitable for use with all of the above types of fluid dispensing arrangements. As used herein, the word ‘tap’ includes ‘faucet’.

According to a first aspect of the present invention there is provided a fluid supply system suitable for domestic applications comprising:

at least one tap having a tap body with at least one fluid inlet and a fluid dispensing outlet and
a diverter valve unit spatially separate from the tap and having a plurality of fluid inlets and at least one fluid outlet, each inlet being connected in use to a different fluid supply and the outlet being connected to a tap fluid inlet, or each outlet being connected to a respective tap fluid inlet,
wherein the diverter valve unit comprises at least two user selectable flow paths by selection of which a chosen inlet of the diverter valve unit is connectable by a user to a chosen outlet of the diverter valve unit.

According to a second aspect of the present invention there is provided a plumbing assembly comprising at least one tap having a tap body with at least one fluid inlet and a fluid dispensing outlet the tap being mounted on a first supporting substrate and configured to dispense fluid into a sink, washbasin or the like,

a diverter valve unit mounted on a second supporting substrate and having a plurality of fluid inlets and at least one fluid outlet
inlet connecting means by means of which each fluid inlet is connected to a respective different fluid supply
outlet connecting means by means of which the outlet is connected to a tap fluid inlet,
wherein the diverter valve unit comprises at least two user selectable flow paths by selection of which a chosen inlet of the diverter valve unit is connectable by a user to a chosen outlet of the diverter valve unit.

In particularly preferred embodiments of these aspects of the invention the tap and the diverter valve unit are independently controllable.

In some preferred embodiments the diverter valve unit comprises a diverter valve and a diverter valve control unit, the valve and the control unit preferably being spatially separate. In one preferred example, the diverter valve is a solenoid operated valve, the solenoid being operated by a control unit including an electric or electronic switch arrangement.

In a particularly preferred arrangement the diverter valve unit comprises first and second inlets and one outlet.

In one preferred embodiment a first inlet of the diverter valve unit is connected to a mains water supply, a second inlet of the diverter valve is connected to a treated water supply and the diverter valve unit comprises one outlet selectively connectable by a selected flow path to said first or said second inlet. Preferably the treated water is selected from softened water and filtered water.

In further preferred arrangements the fluid supply system or plumbing assembly comprises a hot water feed to a flow pathway of the tap controlled by a hot water flow control valve and the outlet of the diverter valve unit feeds to a flow pathway of the tap controlled by a cold water flow control valve.

In alternative preferred embodiments a first inlet of the diverter valve unit is connected either to a mains cold water supply or to a hot water supply, a second inlet of the diverter valve unit is connected to a stored water supply or a non-potable water supply and the diverter valve unit comprises one outlet selectively connectable by a user selectable flow path to said first or said second inlet.

Preferably the stored or non-potable water supply is collected rainwater, water from wells or bore-holes, untreated river or stream water or recycled waste water.

In some preferred embodiments the first inlet of the diverter valve is connected to a hot water supply.

Preferably the stored or non-potable water supply connected to the second inlet of the diverter valve is collected rain water.

Preferably in the plumbing assembly the first substrate is a first marginal region of the sink, washbasin or the like.

Also in a preferred plumbing assembly the second substrate is a second marginal region of the sink, washbasin or the like.

Alternatively in a preferred plumbing assembly one or both of the first and second substrates is a work surface such as a kitchen work surface.

In further preferred embodiments, one or more inlets of the diverter valve unit may include, or may be connected to, a flow restricting or constricting device. Such an arrangement can be useful as a water-saving arrangement. The inlet including, or served via the flow restricting device may be arranged to carry mains water (hot or cold) or treated or non-potable water, for example, at the user's choice on installation. In preferred arrangements, the diverter valve unit may have one or more inlets which are flow restricted and one or more inlets which are not flow restricted, enabling a user to chose the water-saving restricted flow if required. In a variation, a flow restricting or constricting device may be provided at or after one or more outlets of the diverter valve unit.

According to a third aspect of the present invention there is provided a kit of parts for modifying a fluid supply system including a tap having a tap body with at least one fluid inlet having at least a first fluid feed connected thereto whereby the modified system can dispense at least one additional fluid from an additional fluid feed through the tap, the kit comprising a diverter valve unit having a plurality of fluid inlets and at least one fluid outlet, means for connecting a first diverter valve unit inlet to the first fluid feed, means for connecting a second diverter valve inlet to an additional fluid feed and means for connecting a diverter valve unit outlet to the tap fluid inlet, wherein the diverter valve unit comprises at least two user selectable flow paths by selection of which a chosen inlet of the diverter valve unit is connectable by a user to a chosen outlet of the diverter valve unit.

Preferably the kit of parts further comprises mounting means configured for mounting the diverter valve unit in a user accessible location spaced apart from the dispensing means.

Preferably the diverter valve in the kit of parts comprises first and second inlets and one outlet.

The kit of parts may comprise a flow restricting device at, in or connectable to an inlet of the diverter valve unit.

According to a fourth aspect of the present invention there is provided a method of modifying a fluid supply system including a tap having a tap body with at least one fluid inlet having at least a first fluid feed connected thereto so that the modified system can dispense at least one additional fluid from an additional fluid feed through the tap, the method including the steps of mounting a diverter valve unit in a location spatially separate from the tap, the diverter valve unit having a plurality of fluid inlets and at least one fluid outlet, disconnecting the first fluid feed from the tap, connecting a first diverter valve unit inlet to the first fluid feed, connecting a second diverter valve unit inlet to an additional fluid feed and connecting a diverter valve unit outlet to the tap fluid inlet, wherein the diverter valve comprises at least two user selectable flow paths by selection of which a chosen inlet of the diverter valve unit is connectable by a user to a chosen outlet of the diverter valve unit such that either the first fluid feed or the additional fluid feed is in communication with the tap fluid inlet.

Preferably the diverter valve unit comprises first and second inlets and one outlet.

A sixth aspect of the invention provides a diverter valve unit including any novel feature or novel combination of features of the diverter valve described herein.

Further aspects of the invention respectively provide a fluid dispensing system, a kit of parts, a plumbing assembly and methods of modifying a fluid dispensing system which comprises, uses or incorporates a diverter valve unit including any novel feature or novel combination of features of the diverter valve described herein.

For a better understanding of the invention and to show how the same may be carried into effect reference will be made to the following drawings in which:

FIG. 1 shows a typical touch tap in a domestic water supply arrangement including a water softener;

FIG. 2 shows a typical touch tap in a domestic water supply arrangement including a water filter;

FIG. 3 shows a typical example of a conventional three way tap suitable for a conventional domestic water supply system including a water softener or a water filter;

FIG. 4a illustrates a typical conventional twin supply dual flow tap design where the two flows are kept separate until the point of release from the tap;

FIG. 4b illustrates a typical conventional twin supply single flow tap design where two flows are mixed in the tap body and as they emerge from the tap head;

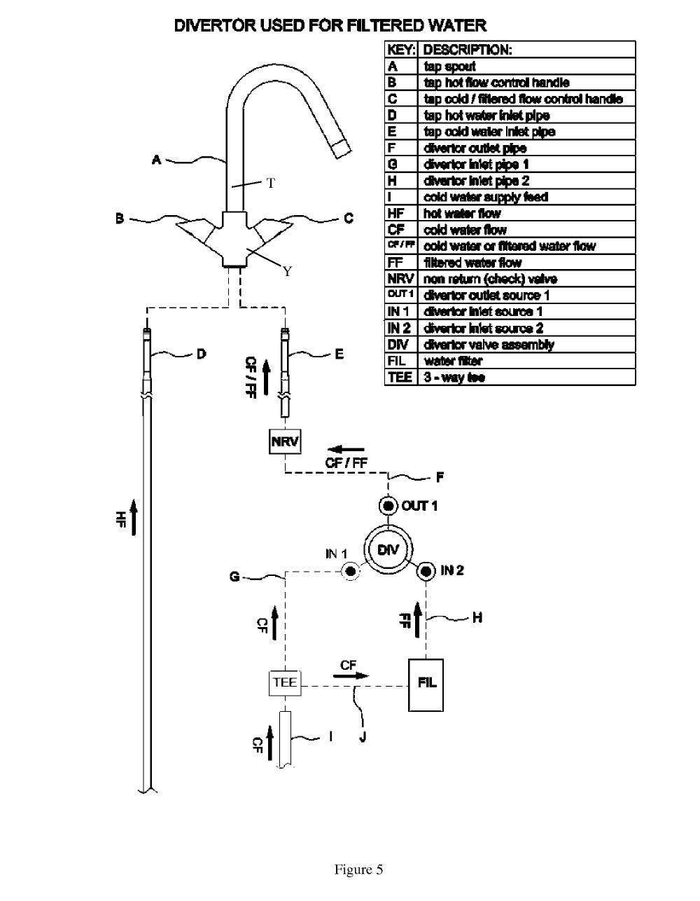

FIG. 5 is a schematic illustration of fluid dispensing system according to a first embodiment of the present disclosure;

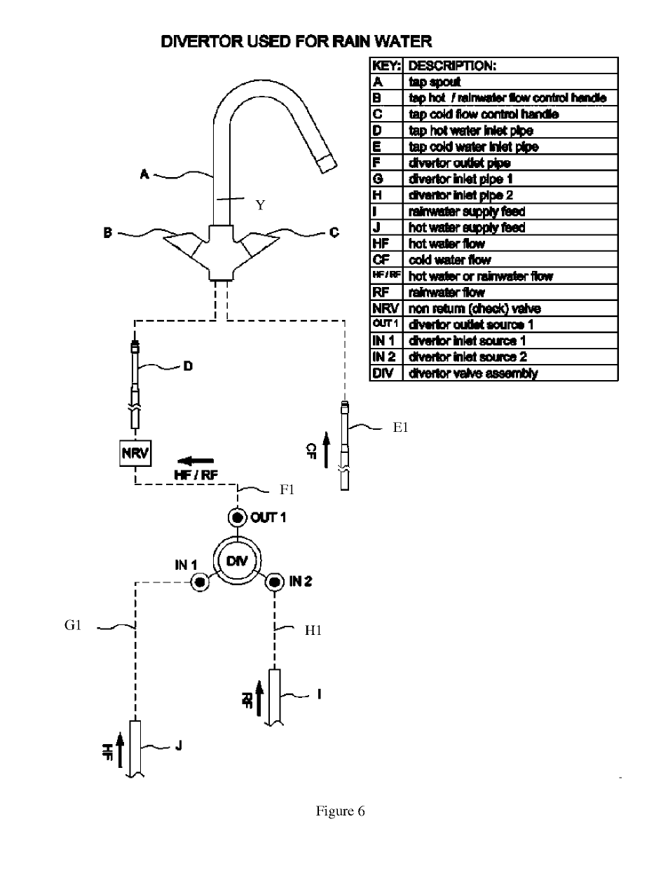

FIG. 6 is a schematic illustration of fluid dispensing system according to a second embodiment of the present disclosure;

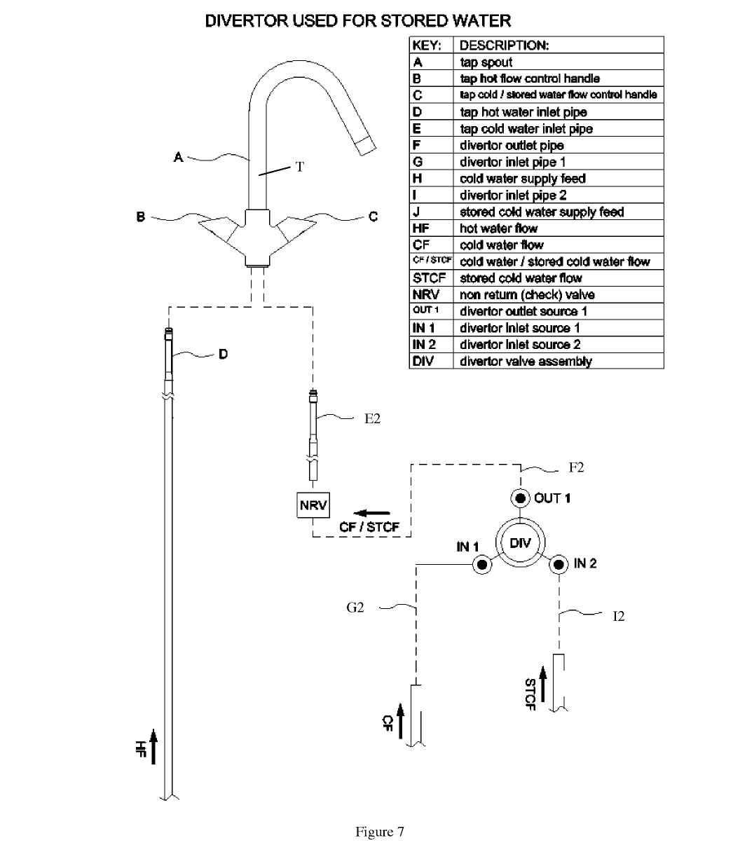

FIG. 7 is a schematic illustration of fluid dispensing system according to a third embodiment of the present disclosure;

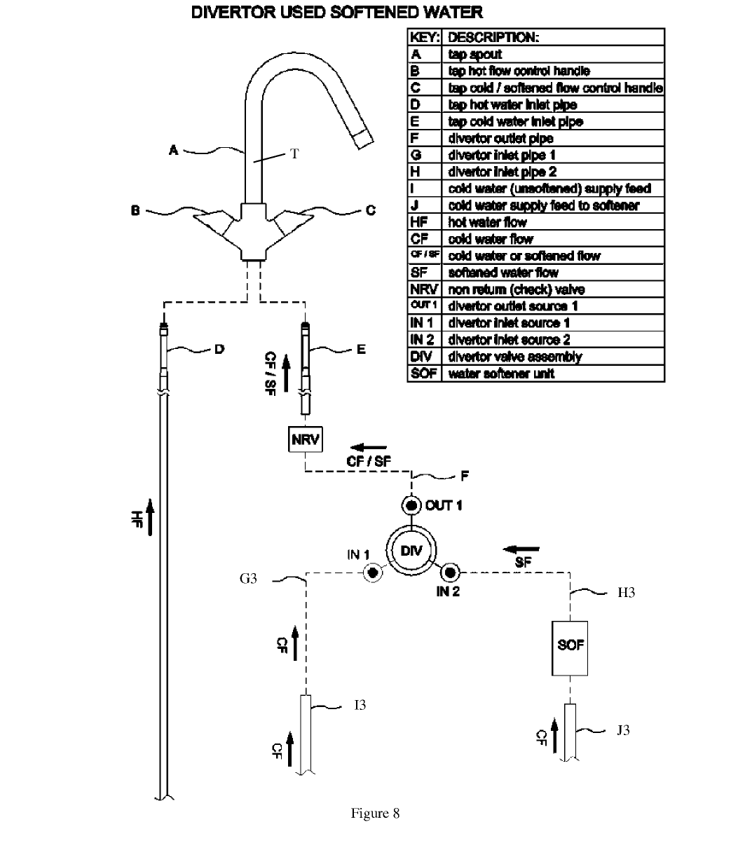

FIG. 8 is a schematic illustration of fluid dispensing system according to a fourth embodiment of the present disclosure;

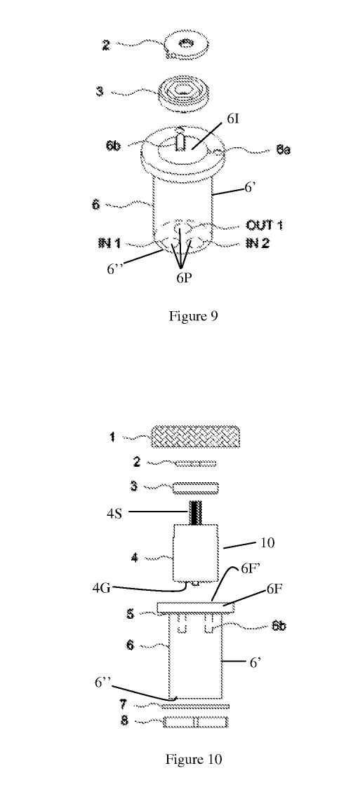

FIG. 9 shows in exploded perspective view certain internal components of a diverter device according to the present disclosure;

FIG. 10 shows in exploded side view the components of FIG. 10 together with further components of the diverter device;

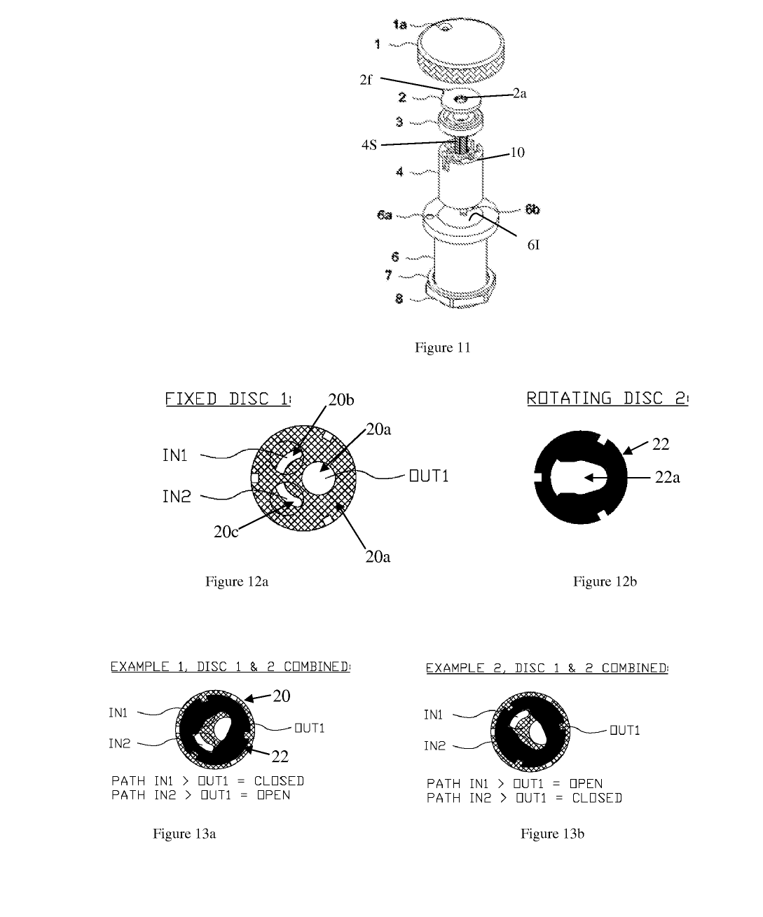

FIG. 11 shows in exploded perspective view the components of the diverter device;

FIG. 12a shows a plan view of a first flow control disc for use in the diverter valve according to the invention and FIG. 12b shows a plan view of a second flow control disc for use in the diverter valve according to the invention;

FIGS. 13a and 13b show respective operating configurations of the flow control discs; and

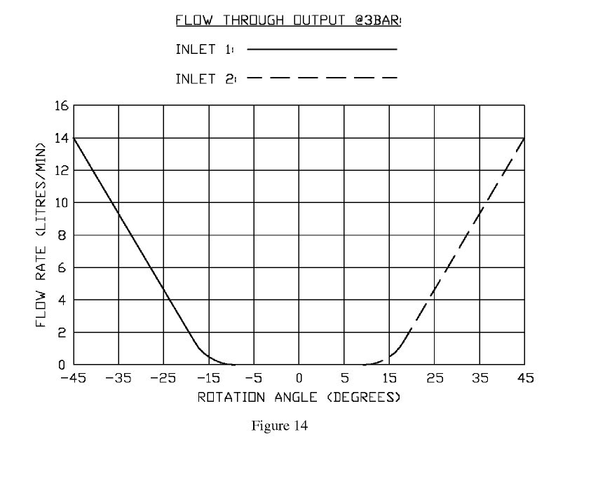

FIG. 14 is a graph showing flow rates through the diverter valve in relation to the rotational position of the valve.

Referring initially to FIG. 5 of the accompanying drawings there is shown a system according to one embodiment of the invention in which a diverter device (DIV) is used to modify an exiting cold water supply to provide a supply of filtered water. In FIG. 5, a standard two-way single or dual flow tap T comprises a body Y, tap spout A, hot flow control handle B and a further control handle C for cold or filtered water. The respective flow control handles B, C determine the position of flow control valves to which they are attached. Hot water is fed to the tap T by means of inlet pipe D and the flow of hot water is controlled by flow control handle B. By means of a diverter device (DIV) a user is able to select either cold water or filtered water to be fed to the tap by inlet pipe E. The primary supply of cold water is via supply feed I which is typically directly connected to the water mains supply or indirectly via a mains-connected cold water tank. Supply feed I feeds cold water to a three-way junction (TEE) having one inlet and two outlets. From one outlet of the junction (TEE) cold water is fed via diverter inlet pipe G and inlet IN1 to the diverter device DIV. Cold water is also fed via pipe J from the other outlet of junction (TEE) to the water filter (FIL) and thence, as filtered water, along inlet pipe H to a second inlet IN2 of the diverter device DIV. From diverter device DIV the water, which, depending on a user's selection, may be either cold water or filtered water, exits via outlet OUT1 into outlet pipe F and thence to a non-return (check) valve (NRV). From the check valve (NRV) the water is fed along inlet pipe E into the tap assembly T. The flow of water from outlet OUT1 for dispensing through spout A is controlled by control handle C. By selecting the appropriate flow path through diverter device (DIV) a user is able to choose either filtered water or mains cold water, to be dispensed via spout A. Installation of the diverter device (DIV) in conjunction with the water filter (FIL) can be achieved without any modification of tap T and without the provision of an additional tap such as a touch tap.

Thus, in the system of FIG. 5, the diverter valve may be used to select either normal cold water or, alternatively, filtered water which is then fed to the tap assembly T.

Referring now to FIG. 6 of the accompanying drawings, the arrangement shown allows a choice to be made between hot water or an alternative water source, such as stored or non-mains water, and in particular rain water, in addition to the normal (mains) cold water flow. Other alternative water sources may include wells, bore-holes, river or stream water and suitably cleaned (to the extent necessary) recycled waste water. In this case the cold water is fed (usually directly from the mains supply or via a mains-connected cold water tank) to the tap assembly T via inlet pipe E1. The flow of mains-derived cold water is controlled by control handle C. Hot water is fed, typically from a conventional water heating apparatus, along inlet pipe G1 to inlet IN1 of a diverter device (DIV). Rain water, other alternative (non-mains) water, is fed to inlet IN2 of the diverter device DIV via inlet pipe H1. A user selects the desired water supply (hot water or the alternative water source such as rain water) by appropriate adjustment of the diverter device (DIV) and the selected supply exits from diverter device (DIV) via outlet OUT1 and passes along outlet pipe F1 to non-return (check) valve (NRV) and thence along inlet pipe D to the tap assembly T. Flow control handle B controls the flow of water fed by pipe D.

Thus, selection of the appropriate inlet IN1 or IN2 by diverter device (DIV) allows a choice of either hot water or the alternative water source such as rain water to be fed to the tap assembly.

Referring now to FIG. 7 of the accompanying drawings, the arrangement shown allows a choice to be made between intermittent direct cold water and stored cold water, in addition to the normal hot water flow. In this case hot water is fed to the tap assembly T via inlet pipe D and the flow of hot water is controlled by control handle B. Cold water (CF), normally from a mains supply, is fed to the diverter device (DIV) along inlet pipe G2 and inlet IN1. Stored cold water (STCF) is fed to the diverter device (DIV) along pipe 12 and inlet IN2. A user selects a desired water flow (cold water or stored cold water) by adjustment of the diverter device (DIV) and the selected flow exits the diverter device (DIV) via outlet OUT1 and passes along outlet pipe F2 to non-return (check) valve NRV and thence along inlet pipe E2 to the tap assembly T where the flow is controlled by control handle C.

Thus, selection of the appropriate inlet IN1 or IN2 of diverter device (DIV) by a user allows a choice of either cold (mains) water or stored cold water to be fed to the tap assembly T.

Referring now to FIG. 8 of the accompanying drawings, the arrangement shown here allows a choice to be made between the normal cold water supply and softened water. This arrangement is similar to that shown in FIG. 5 and differs only in the feeds to the diverter device (DIV). Cold water from supply feed I3 is fed to inlet IN1 of diverter device (DIV) along inlet pipe G3. Cold water is fed from supply feed 33 to water softener apparatus (SOF) and thence along inlet pipe H3 and inlet IN2 to the diverter device (DIV).

Thus, appropriate selection by a user of inlet IN1 or IN2 will allow normal cold water or softened water to be supplied to the tap assembly T without modification of the tap assembly or the provision of an additional tap.

It should be appreciated that many other examples of applications of the present invention may be provided. The following table gives both the above described examples and a number of further examples of such applications.

| | | DIVERTER | |
|---|---|---|---|
| | | OUTLET | |
| | TYPE OF | MIGHT FEED | |
| | TAP | WHICH INLET | |
| FLUID | SUITED | OF EXISTING | |
| SOURCE TYPE | TO | MIXER TAPS | NOTES |
| Filtered water | Dual or | Cold inlet | For use with carbon filtered or |
| (see FIG. 5) | single flow | | reverse osmosis water source, for |
| | | | example |
| Softened water | Dual or | Cold inlet | Water source would be from a mains |
| (see FIG. 8) | single flow | | supply after treatment by a water |
| | | | softener. Note softened water |
| | | | should not be drunk. |
| Boiling water | Dual or | Hot inlet | Used in conjunction with a “zip” |
| (configuration | single flow | | boiler or similar technology boiling |
| similar to FIG. 6) | | | water can be delivered from the tap |
| | | | for hot drinks, food preparation or |
| | | | cleaning. Note: diverter valve may |
| | | | incorporate a “child lock” for safety |
| | | | purposes. |
| Chilled water | Dual or | Cold inlet | A pre-chilled water source that could |
| (configuration | single flow | | be pre-filtered also. |
| similar to FIG. 7) | | | |
| Detergent and | Dual flow | Hot inlet | Pre-mixed source of hot water and |
| water mixed | only | | detergent, set at an accurate dose |
| (configuration | | | which should use less detergent |
| similar to FIG. 6) | | | than manual dosing |
| Non-potable | Dual flow | Hot inlet | Sources may include wells, bore |
| water (see | only | | holes, recycled wastewater or rain |
| FIG. 6) | | | water. Should result in water usage |
| | | | savings. |
| Carbonated | Dual or | Cold inlet | Water source is pre-compressed with |
| water | single flow | | Carbon dioxide or similar gases to |
| (configuration | | | provide “Fizzy” water. |
| similar to FIG. 5) | | | |
| Enhanced water | Dual or | Cold inlet | Water source could have added |
| (configuration | single flow | | flavouring or health enhancing |
| similar to FIG. 5) | | | chemicals or minerals (e.g. Calcium) |

One example of a diverter valve is shown in FIGS. 9, 10 and 11. In this example, the diverter valve 10 comprises a substantially cylindrical housing 6 comprising an outer wall 6′ and a base wall 6″ which define a cylindrical internal bore 61. The housing 6 may be made from machined brass or other similarly suitable material. The diverter valve 10 further comprises a diverter body or cartridge 4 which is received into the internal bore 61 of housing 6. Housing 6 is sized to be received into a conventional hole or bore of a mounting substrate such as a sink or worktop, which substrate hole or bore is typically about 35 mm in diameter. The housing 6 includes an upper flange or shoulder 6F depending from wall 6′ which is configured to be wider than the diameter of the substrate hole or bore, whereby the flange 6F rests in use on an upper surface of the mounting substrate. A seal 5, such as a washer or O-ring is located immediately below the flange 6F and acts in use to prevent any water ingress from the mounting substrate surface to the substrate bore or hole. The housing 6 also carries a fixing nut 8 and a lower seal 7 such as a washer or O-ring. Tightening of the fixing nut 8 urges the seal 7 into engagement with the underside of the mounting substrate. The resulting compression of the seals 5 and 7 assists in securing the housing 6 to the mounting substrate and in preventing rotation of the diverter valve 10 relative to the mounting substrate. Base wall 6″ is provided with a plurality of orifices which serve as inlet or outlet ports 6P, depending on the particular configuration of the diverter valve 10 in use.

The diverter cartridge 4 is secured in the internal bore 61 of the housing by an externally threaded retaining nut 3 which cooperates with a corresponding internal thread on the surface of bore 61. Tightening of the retaining nut 3 urges the diverter cartridge towards base wall 6″ so that a seating gasket 4G is in compression between the diverter cartridge 4 and the base wall 6″. This construction ensures evenly distributed compression of the gasket 4G. A splined shaft or spindle 4S extends axially upwardly (as illustrated) from the diverter cartridge 4 and is fixedly attached to an operating handle 1. The spindle 4S is free to rotate about its axis, at least within defined limits. Operating handle 1 is configured so that it is easily gripped by a user in order to rotate the handle 1, and consequently also the spindle 4S.

The valve cartridge 4 includes a pair of flow controlling discs 20, 22 as shown in FIGS. 12a and 12b which are typically made from a ceramic material. A first disc 20 is arranged in a fixed (non-rotatable) position in which it is juxtaposed with the respective inlet(s) and outlet(s) 6P. In the particular configuration of the illustrated example, first disc 20 includes three orifices or apertures, 20a, 20b and 20c. Orifice 20a is substantially circular and is aligned in the illustrated example with one of the ports 6P which serves as outlet OUT1. Orifices 20b and 20c are respectively approximately arcuate and are aligned respectively with the ports 6P serving as inlets IN1 and IN2. The respective orifices 20a, 20b and 20c may of course have different shapes, but the illustrated shapes are effective in maximising the flow capacity of the diverter valve 10. A second disc 22 rests in use in face-to-face contact with first disc 20. Second disc 22 is rotatably mounted and is fixedly connected, directly or indirectly, to the spindle 4S. Hence rotation of operating handle 1 by a user causes a corresponding rotation of rotatable disc 22. The diverter valve 10 is configured so that disc 22 is moveable between two positions. Typically, these positions form the limits of permitted movement of the disc 22. The respective positions are illustrated in FIGS. 13a and 13b. Rotatable disc 22 includes a single orifice 22a which is shaped and configured so that in the first of the two positions, as illustrated in FIG. 13a, the orifice 22a exposes orifices 20a and 20b of fixed disc 20 and closes orifice 20c of fixed disc 20. Thus a flow path is provided only from inlet IN2 via orifices 20b and 20a to outlet port OUT1. No flow is possible through inlet port IN1. Conversely, in the second of the two positions, as illustrated in FIG. 13b, the orifice 22a exposes orifices 20a and 20c of fixed disc 20 and closes orifice 20b of fixed disc 20. Thus a flow path is provided only from inlet IN1 via orifices 20c and 20a to outlet port OUT1. In intermediate positions of the second disc one or other of the orifices 20b, 20c is partially open, but the two orifices 20b, 20c are not concurrently exposed. In an intermediate position approximately half way through the permitted movement of the disc is a configuration in which both orifices 20b, 20c are closed by rotatable disc 22. Thus, any possibility of cross-flow and contamination between the feeds to inlet ports IN1 and IN2 is eliminated. A typical flow pattern in relation to the rotational position of the rotatable plate is illustrated in FIG. 14. It can be seen that the flow through a given orifice is at a maximum at the respective movement limits of the rotatable disc, and that the flow diminishes towards a central rotation position of the rotatable disc 22 at which there is no flow.

In the embodiment illustrated, the diverter valve 10 is further provided with means which indicate to a user that the valve 10 is set in one or other of its operating positions, that is, at the limits of movement of the rotatable disc 22 at which the flow through the exposed orifice 20b or 20c is maximal. To this end, the upper surface 6F′ is provided with a number of visual position indicators 6a such as markings or indentations or the like. The operating handle 1 is provided with a “window” is (such as a small through bore). The indicators 6a and is are configured so that a respective indicator 6a is visible only when the valve 10 is in one of its operating positions. Of course, if a particular valve 10 has more than two operating positions, for example in the case where the valve has more than three inlet and outlet ports in total then a correspondingly higher number of indicators 6a is provided so that there is one indicator 6a for each operating position. In alternative arrangements, one or more markings visible to a user may be provided on the handle 1, for example on an upper surface thereof, to indicate the setting of the valve 10. For example, such markings may align with a visible marking on a fixed portion of the diverter valve 10 or a marking on an adjacent substrate to which the valve 10 is mounted, to indicate the setting of the valve 10.

To enhance further the positional information which is available to a user concerning the valve 10, a “click device” may desirably be included which provides a user with an audible and/or sensory indication that the valve 10 is set in a use position. In this embodiment, the internal wall of housing 6 is provided at its upper regions with a plurality of notches or grooves 6b. Each groove 6b corresponds to an operating position of the valve 10, that is, a position in which one of the orifices of the fixed disc 20, such as illustrated orifices 20b, 20c is fully exposed by rotating disc 22. A clicker plate 2 has an internally splined bore 2a. Clicker plate 2a is mounted on spindle 4S and, by virtue of the respective splined surfaces, the clicker plate 2 rotates as one with the spindle 4S. Clicker plate 2 includes a radially projecting formation 2f which is received into a given notch 6b when the valve 10 is in one of its operating positions. The projection 2f enters the given notch 6b with a user-audible click which may also be felt by a user's hand through operating handle 1.

Desirably, means may also be provided to limit the rotational movement of the rotatable disc 22 (and of the spindle 4S and operating handle 1) so that they cannot be over-rotated, i.e. so that they cannot be rotated beyond there desirable movement limits of the disc 22 corresponding to angularly most spaced apart operating positions. Of course, in the case of a valve having a higher number of operating positions than those illustrated in the Figures, there may be no benefit in providing such movement limiting means. In one embodiment, the movement limiting means are provided by co-operating formations of the housing 6 and valve cartridge 4. For example, the spindle 4S may be provided with one or more radially extending pins, distal ends of which are accommodated in respective circumferential grooves formed in the inner surface of wall 6′. The length of these grooves is and their respective position determine the permitted range of movement of the spindle 4S and consequently of the rotatable disc 22.

It is also within the scope of the present invention that the device may comprise a total of four or five or more inlets and outlets. For example, the device may have one outlet and three inlets. The three inlets may comprise cold water, filtered cold water and softened cold water. The operating handle 1 would then allow selection of the three outlets. In another example, the device may have one outlet and four inlets. The four inlets may comprise cold water, filtered cold water, stored cold water and softened cold water. The operating handle 1 would then allow selection of the four outlets.

Throughout the description and claims of this specification, the words “comprise” and “contain” and variations of the words, for example “comprising” and “comprises”, means “including but not limited to”, and is not intended to (and does not) exclude other moieties, additives, components, integers or steps.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

1. A fluid supply system suitable for domestic applications comprising:
at least one tap having a tap body with at least one fluid inlet and a fluid dispensing outlet, and
a diverter valve unit spatially separate from the tap and having a plurality of diverter valve fluid inlets and at least one diverter valve fluid outlet, each diverter valve fluid inlet being connected in use to a different fluid supply and at least one diverter valve fluid outlet being connected to a tap fluid inlet,
wherein the diverter valve unit comprises at least two user selectable flow paths by selection of which a chosen diverter valve fluid inlet is connectable by a user to a chosen diverter valve fluid outlet.

2. A plumbing assembly comprising:
at least one tap having a tap body with at least one fluid inlet and a fluid dispensing outlet, the tap being mounted on a first supporting substrate and configured to dispense fluid into a sink,
a diverter valve unit mounted on a second supporting substrate and having a plurality of diverter valve fluid inlets and at least one diverter valve fluid outlet,
at least one fluid supply,
inlet connecting means by means of which each diverter valve fluid inlet is connected to a respective different fluid supply, and
outlet connecting means by means of which at least one diverter valve fluid outlet is connected to a tap fluid inlet,
wherein the diverter valve unit comprises at least two user selectable flow paths by selection of which a chosen diverter valve fluid inlet is connectable by a user to a chosen diverter valve fluid outlet.

3. A fluid supply system as claimed in claim 1, wherein the tap and the diverter valve unit are independently controllable.

4. A fluid supply system as claimed in claim 1, wherein the diverter valve unit comprises a diverter valve and a diverter valve control unit, the diverter valve and the diverter valve control unit being spatially separate.

5. A fluid supply system as claimed in claim 1, wherein the diverter valve unit comprises first and second diverter valve fluid inlets and one diverter valve fluid outlet.

6. A fluid supply system as claimed in claim 1, wherein a first diverter valve fluid inlet is connected to a mains water supply, a second diverter valve fluid inlet is connected to a treated water supply, and the diverter valve unit comprises one diverter valve fluid outlet selectively connectable by a selected flow path to said first or said second diverter valve fluid inlet.

7. A fluid supply system as claimed in claim 6, wherein the treated water is selected from the group consisting of softened water and filtered water.

8. A fluid supply system as claimed in claim 6 further comprising a hot water feed to a flow pathway of the tap controlled by a hot water flow control valve, and
wherein the diverter valve fluid outlet feeds to a flow pathway of the tap controlled by a cold water flow control valve.

9. A fluid supply system as claimed in claim 1, wherein a first diverter valve fluid inlet is connected to one of a mains cold water supply or a hot water supply, a second diverter valve fluid inlet is connected to one of a stored water supply or a non-potable water supply, and the diverter valve unit comprises one diverter valve fluid outlet selectively connectable by a user selectable flow path to said first or said second diverter valve fluid inlet.

10. A fluid supply system as claimed in claim 1 further comprising a flow restricting means at, or connected to, a diverter valve fluid inlet.

11. (canceled)

12. A plumbing assembly as claimed in claim 2, wherein the first substrate is a first marginal region of the sink.

13. A plumbing assembly as claimed in claim 2, wherein the second substrate is a second marginal region of the sink.

14. A plumbing assembly as claimed in claim 2, wherein one or both of the first and second substrates is a work surface.

15. A kit of parts for modifying a fluid supply system including a tap having a tap body with at least one fluid inlet having at least a first fluid feed connected thereto whereby the modified system can dispense at least one additional fluid from an additional fluid feed through the tap, the kit comprising:
a diverter valve unit having a plurality of fluid inlets and at least one fluid outlet,
means for connecting a first diverter valve unit inlet to the first fluid feed,
means for connecting a second diverter valve inlet to an additional fluid feed, and
means for connecting a diverter valve unit outlet to the tap fluid inlet,
wherein the diverter valve unit comprises at least two user selectable flow paths by selection of which a chosen inlet of the diverter valve unit is connectable by a user to a chosen outlet of the diverter valve unit.

16. A kit of parts as claimed in claim 15 further comprising mounting means configured for mounting the diverter valve unit in a user accessible location spaced apart from the dispensing means.

17. A kit of parts as claimed in claim 15, wherein the diverter valve comprises first and second inlets and one outlet.

18. A method of modifying a fluid supply system including a tap having a tap body with at least one fluid inlet having at least a first fluid feed connected thereto so that the modified system can dispense at least one additional fluid from an additional fluid feed through the tap, the method comprising:
mounting a diverter valve unit in a location spatially separate from the tap, the diverter valve unit having a plurality of fluid inlets and at least one fluid outlet, disconnecting the first fluid feed from the tap,
connecting a first diverter valve unit inlet to the first fluid feed,
connecting a second diverter valve unit inlet to an additional fluid feed, and
connecting a diverter valve unit outlet to the tap fluid inlet,
wherein the diverter valve comprises at least two user selectable flow paths by selection of which a chosen inlet of the diverter valve unit is connectable by a user to a chosen outlet of the diverter valve unit such that either the first fluid feed or the additional fluid feed is in communication with the tap fluid inlet.

19. A method as claimed in claim 18, wherein the diverter valve unit comprises first and second inlets and one outlet.

20-23. (canceled)
